(19) United States
(12) Patent Application Publication
(10) Pub. No.: US 2024/0146642 A1
(43) Pub. Date: May 2, 2024

(54) BIER-TE Encapsulation With Multiple Sets

(71) Applicant: HUAWEI TECHNOLOGIES CO., LTD., Shenzhen (CN)

(72) Inventor: Huaimo Chen, Bolton, MA (US)

(21) Appl. No.: 18/408,160

(22) Filed: Jan. 9, 2024

Related U.S. Application Data
(63) Continuation of application No. PCT/US2022/036512, filed on Jul. 8, 2022.
(60) Provisional application No. 63/220,053, filed on Jul. 9, 2021.

(51) Int. Cl. H04L 45/16

(52) U.S. Cl. CPC H04L 45/16

(57) ABSTRACT

A method implemented by a BFR in a BIER-TE domain. The method includes receiving a packet with a BIER-TE header, where the BIER-TE header includes an indicator indicating a number of the bitstrings in the BIER-TE header, and a set identifier for each of the bitstrings; checking whether a bitstring identified by the set identifier in the BIER-TE header and a bitstring identified by the set identifier in a top level BIFT each contain an adjacency bit position of the BFR with a same value; and processing the packet using a second level BIFT that a pointer for the set identifier in the top level BIFT points to when the two bitstrings each contain the adjacency bit position of the BFR with the same value.

### CROSS-REFERENCE TO RELATED APPLICATIONS

This patent application is a continuation of International Application No. PCT/US2022/036512 filed on Jul. 8, 2022, which claims the benefit of U.S. Provisional Patent Application No. 63/220,053 filed Jul. 9, 2021, each of which is hereby incorporated by reference.

### TECHNICAL FIELD

The present disclosure is generally related to the field of network communication and, in particular, to Bit Index Explicit Replication-Traffic/Tree Engineering (BIER-TE).

### BACKGROUND

BIER mechanisms provide optimized forwarding of multicast data packets through a BIER domain BIER domains may not require the use of a protocol for explicitly building multicast distribution trees. Further, BIER domains may not require intermediate nodes to maintain any per-flow state. BIER is described in further detail in Internet Engineering Task Force (IETF) document Request for Comments (RFC) 8279 entitled “Multicast Using Bit Index Explicit Replication (BIER)” by I J. Wijnands, et al., published November 2017.

Traffic Engineering (TE) is the process of steering traffic across a telecommunications network to facilitate efficient use of available bandwidth between a pair of routers. Bit Index Explicit Replication (BIER) Traffic/Tree Engineering (BIER-TE) is described in IETF document “Tree Engineering for Bit Index Explicit Replication (BIER-TE)” by T. Eckert, et al., published Jul. 9, 2021.

### SUMMARY

The disclosed aspects/embodiments provide techniques that provide a BIER-TE header capable of accommodating more than one set of bitstrings, updated bit index forwarding tables (BIFTs), and an enhanced forwarding procedure for efficiently processing the BIER-TE header with multiple sets of bit positions. Using the BIER-TE header and the updated BIFTs, packet routing within the BIER-TE domain is improved relative to existing techniques.

A first aspect relates to a method implemented by bit forwarding ingress router (BFIR) in a Bit Index Explicit Replication Traffic/Tree Engineering (BIER-TE) domain, comprising: encapsulating a packet with a BIER-TE header, wherein the BIER-TE header includes an indicator indicating a number of the bitstrings with different set identifiers in the BIER-TE header, and a set identifier for each of the bitstrings; and forwarding the packet as encapsulated with the BIER-TE header to a bit forwarding router (BFR) in the BIER-TE domain.

Optionally, in any of the preceding aspects, another implementation of the aspect provides that the bitstrings with different set identifiers in the BIER-TE header represent a path through the BIER-TE domain.

Optionally, in any of the preceding aspects, another implementation of the aspect provides that the path is received from a controller of the BIER-TE domain prior to the encapsulating.

Optionally, in any of the preceding aspects, another implementation of the aspect provides that the number has the value greater than one (1) when the BIER-TE header contains the multiple bitstrings with the different set identifiers.

Optionally, in any of the preceding aspects, another implementation of the aspect provides that the number has the value of one (1) when the BIER-TE header does not contain the multiple bitstrings with the different set identifiers.

A second aspect relates to a bit forwarding ingress router (BFIR) in a Bit Index Explicit Replication Traffic/Tree Engineering (BIER-TE) domain, comprising: a memory storing instructions; and a processor coupled to the memory, the processor configured to execute the instructions to cause the BFIR to: encapsulate a packet with a BIER-TE header, wherein the BIER-TE header includes an indicator indicating a number of the bitstrings with different set identifiers in the BIER-TE header, and a set identifier for each of the bitstrings; and forward the packet as encapsulated with the BIER-TE header to a bit forwarding router (BFR) in the BIER-TE domain.

Optionally, in any of the preceding aspects, another implementation of the aspect provides that the bitstrings with different set identifiers in the BIER-TE header represent a path through the BIER-TE domain.

Optionally, in any of the preceding aspects, another implementation of the aspect provides that the path is received from a controller of the BIER-TE domain prior to the encapsulating.

Optionally, in any of the preceding aspects, another implementation of the aspect provides that the number has the value greater than one (1) when the BIER-TE header contains the multiple bitstrings with the different set identifiers.

Optionally, in any of the preceding aspects, another implementation of the aspect provides that the number has the value of one (1) when the BIER-TE header does not contain the multiple bitstrings with the different set identifiers.

A third aspect relates to a method implemented by a bit forwarding router (BFR) in a Bit Index Explicit Replication Traffic/Tree Engineering (BIER-TE) domain, comprising: receiving a packet with a BIER-TE header, wherein the BIER-TE header includes an indicator indicating a number of the bitstrings with different set identifiers in the BIER-TE header, and a set identifier for each of the bitstrings; checking whether a bitstring identified by the set identifier in the BIER-TE header and a bitstring identified by the set identifier in a top level bit index forwarding table (BIFT) each contain an adjacency bit position of the BFR with a same value; and processing the packet using a second level BIFT that a pointer for the set identifier in the top level BIFT points to when the bitstring identified by the set identifier in the BIER-TE header and the bitstring identified by the set identifier in the BIFT each contain the adjacency bit position of the BFR with the same value.

Optionally, in any of the preceding aspects, another implementation of the aspect provides that processing the packet using the second level BIFT comprises forwarding a copy of the packet to an adjacent bit forwarding router (BFR) when the adjacency bit position is a forward-connected adjacency.

Optionally, in any of the preceding aspects, another implementation of the aspect provides that processing the packet using the second level BIFT comprises forwarding a payload of the packet according to a next protocol when the adjacency bit position is a local decapsulation adjacency.

Optionally, in any of the preceding aspects, another implementation of the aspect provides that each bitstring in the BIER-TE header and each bitstring in the top level BIFT is identified by one of the set identifiers.

Optionally, in any of the preceding aspects, another implementation of the aspect provides that the same value comprises one (1).

Optionally, in any of the preceding aspects, another implementation of the aspect provides that the second level BIFT is one of a plurality of second level BIFTs in the BFR.

Optionally, in any of the preceding aspects, another implementation of the aspect provides that each of the plurality of second level BIFTs in the BFR corresponds to one of the set identifiers.

Optionally, in any of the preceding aspects, another implementation of the aspect provides that the top level BIFT includes a pointer to a second level BIFT for each of the set identifiers.

A fourth aspect relates to a bit forwarding router (BFR) in a Bit Index Explicit Replication Traffic/Tree Engineering (BIER-TE) domain, comprising: a memory storing instructions; and a processor coupled to the memory, the processor configured to execute the instructions to cause the BFR to: receive a packet with a BIER-TE header, wherein the BIER-TE header includes an indicator indicating a number of the bitstrings with different set identifiers in the BIER-TE header, and a set identifier for each of the bitstrings; check whether a bitstring identified by the set identifier in the BIER-TE header and a bitstring identified by the set identifier in a top level bit index forwarding table (BIFT) each contain an adjacency bit position of the BFR with a same value; and process the packet using a second level BIFT that a pointer for the set identifier in the top level BIFT points to when the bitstring identified by the set identifier in the BIER-TE header and the bitstring identified by the set identifier in the BIFT each contain the adjacency bit position of the BFR with the same value.

Optionally, in any of the preceding aspects, another implementation of the aspect provides that the processor processes the packet using the second level BIFT by forwarding a copy of the packet to an adjacent bit forwarding router (BFR) when the adjacency bit position is a forward-connected adjacency.

Optionally, in any of the preceding aspects, another implementation of the aspect provides that the processor process the packet using the second level BIFT by forwarding a payload of the packet according to a next protocol when the adjacency bit position is a local decapsulation adjacency.

Optionally, in any of the preceding aspects, another implementation of the aspect provides that each bitstring in the BIER-TE header and each bitstring in the top level BIFT is identified by one of the set identifiers.

Optionally, in any of the preceding aspects, another implementation of the aspect provides that the same value comprises one (1).

Optionally, in any of the preceding aspects, another implementation of the aspect provides that the second level BIFT is one of a plurality of second level BIFTs in the BFR.

Optionally, in any of the preceding aspects, another implementation of the aspect provides that each of the plurality of second level BIFTs in the BFR corresponds to one of the set identifiers.

Optionally, in any of the preceding aspects, another implementation of the aspect provides that the top level BIFT includes a pointer to a second level BIFT for each of the set identifiers.

A fifth aspect relates to a non-transitory computer readable medium comprising a computer program product for use by a bit forwarding ingress router (BFIR), the computer program product comprising computer executable instructions stored on the non-transitory computer readable medium that, when executed by one or more processors, cause the BFIR to execute one or more of the disclosed embodiments.

A sixth aspect relates to a non-transitory computer readable medium comprising a computer program product for use by a bit forwarding router (BFR), the computer program product comprising computer executable instructions stored on the non-transitory computer readable medium that, when executed by one or more processors, cause the BFR to execute one or more of the disclosed embodiments.

A seventh aspect relates to a bit forwarding ingress router (BFIR) in a Bit Index Explicit Replication Traffic/Tree Engineering (BIER-TE) domain, comprising: means for encapsulating a packet with a BIER-TE header, wherein the BIER-TE header includes an indicator indicating a number of the bitstrings with different set identifiers in the BIER-TE header, and a set identifier for each of the bitstrings; and means for forwarding the packet as encapsulated with the BIER-TE header to a bit forwarding router (BFR) in the BIER-TE domain.

An eighth aspect relates to a bit forwarding router (BFR) in a Bit Index Explicit Replication Traffic/Tree Engineering (BIER-TE) domain, comprising: means for receiving a packet with a BIER-TE header, wherein the BIER-TE header includes an indicator indicating a number of the bitstrings with different set identifiers in the BIER-TE header, and a set identifier for each of the bitstrings; means for checking whether a bitstring identified by the set identifier in the BIER-TE header and a bitstring identified by the set identifier in a top level bit index forwarding table (BIFT) each contain an adjacency bit position of the BFR with a same value; and means for processing the packet using a second level BIFT that a pointer for the set identifier in the top level BIFT points to when the bitstring identified by the set identifier in the BIER-TE header and the bitstring identified by the set identifier in the BIFT each contain the adjacency bit position of the BFR with the same value.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a BIER-TE topology including a BIER-TE domain.

FIG. 2 is a schematic diagram of a BIER-TE bit index forwarding table (BIFT) of a network node in the BIER-TE domain.

FIG. 3 is a schematic diagram of a BIER-TE header according to an embodiment of the disclosure.

FIG. 4 is a schematic diagram of a top level BIFT according to an embodiment of the disclosure.

FIG. 5 is a second level BIFT according to an embodiment of the disclosure.

FIG. 6 is a second level BIFT according to an embodiment of the disclosure.

FIG. 7 is a second level BIFT according to an embodiment of the disclosure.

FIG. 8 is a method implemented by a bit forwarding ingress router (BFIR) in a BIER-TE domain according to an embodiment of the disclosure.

FIG. 9 is a method implemented by a bit forwarding router (BFR) in a BIER-TE domain according to an embodiment of the disclosure.

FIG. 10 is syntax suitable for implementing an enhanced forwarding procedure that corresponds to the method of FIG. 9 according to an embodiment of the disclosure.

FIG. 11 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Existing techniques for BIER-TE are not suitable for a BIER-TE path with multiple sets of bitstrings (a.k.a., BitStrings, bit strings, bit positions, etc.). For example, the existing BIER-TE header is only able to accommodate one set of bitstrings. Thus, the existing BIER-TE header will not work for a BIER-TE path with more than one set of bitstrings. This causes inefficiency and leads to difficulties in computing and setting up paths (e.g., point to multipoint (P2MP) paths) through the BIER-TE domain.

Disclosed herein are techniques that provide a BIER-TE header capable of accommodating more than one set of bitstrings, updated bit index forwarding tables (BIFTs), and an enhanced forwarding procedure for efficiently processing the BIER-TE header with multiple sets of bit positions. Using the BIER-TE header and the updated BIFTs, packet routing within the BIER-TE domain is improved relative to existing techniques.

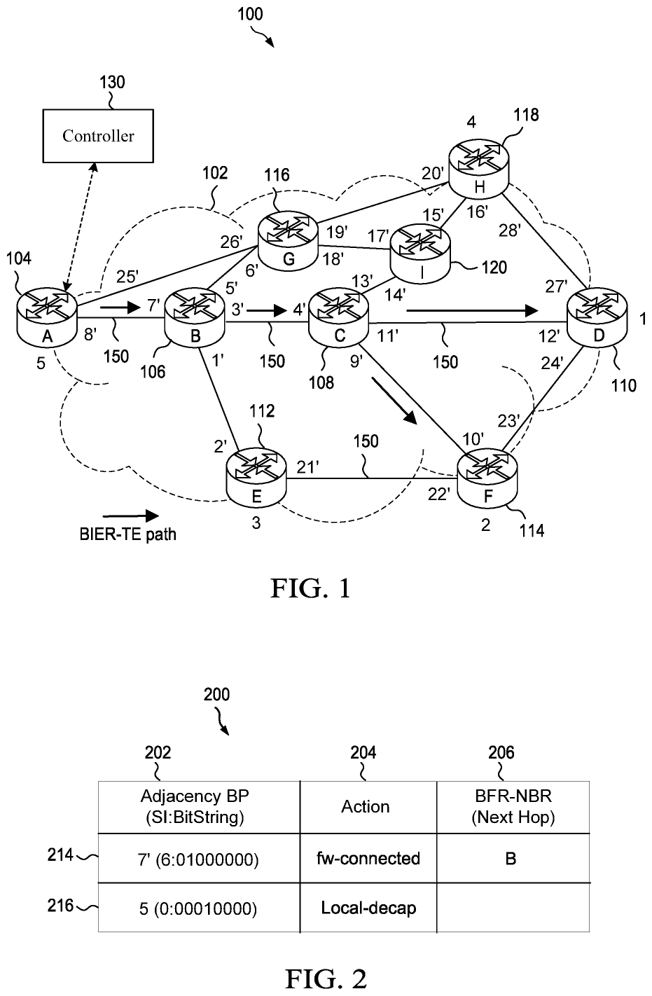

FIG. 1 is a schematic diagram of a BIER-TE topology 100 including a BIER-TE domain 102. The BIER-TE domain 102 may be part of a larger BIER-TE domain (not shown). As such, the BIER-TE domain 102 may be referred to herein as a BIER-TE sub-domain. The BIER-TE domain 102 comprises a plurality of network nodes 104, 106, 108, 110, 112, 114, 116, 118, and 120. While nine network nodes 104-120 are shown in the BIER-TE domain 102, more or fewer nodes may be included in practical applications.

Each of the network nodes 104-120 is a bit forwarding router (BFR). Some of the network nodes, namely the network nodes 104, 110, 112, 114 and 118, are disposed at an edge of the BIER-TE domain 102. The network nodes 104, 110, 112, 114 and 118 receiving multicast packets from outside the BIER-TE domain 102 may be referred to as a bit forwarding ingress router (BFIR) or ingress BFR. The network nodes 104, 110, 112, 114 and 118 transmitting multicast packets out of the BIER-TE domain 102 may be referred to as a bit forwarding egress router (BFER) or egress BFR. Depending on the direction of multicast packet traffic, each of the network nodes 104, 110, 112, 114 and 118 may function as a BFIR or a BEER.

As shown in FIG. 1, the bit position (BP) for forward connected (fw-con) adjacency between the various network nodes 104-120 is identified. In the illustrated example, the BP for a fw-con adjacency is represented as i′, where i is an integer corresponding to one of the forward connected adjacencies between the network nodes 104-120 in the BIER-TE domain 102. In the illustrated embodiment of FIG. 1, there are twenty-eight total BPs for twenty-eight fw-con adjacencies. However, there may be more or fewer BPs for fw-con adjacencies in other BIER-TE domains in practical applications.

As an example of how the BPs for fw-con adjacencies operate with regard to FIG. 1, 7′ is the BP for the fw-con adjacency from node 104 to node 106, and 8′ is the BP for the fw-con adjacency from node 106 to node 104. 7′ is configured on the link from node 104 to node 106 and advertised to all the network nodes in the network. 8′ is configured on the link from node 106 to node 104 and advertised to all the network nodes in the network. As another example, 4′ is the BP for the fw-con adjacency from node 106 to node 108, and 3′ is the BP for the fw-con adjacency from node 108 to node 106. 4′ is configured on the link from node 106 to node 108 and advertised to all the network nodes in the network. 3′ is configured on the link from node 108 to node 106 and advertised to all the network nodes in the network. As another example, 2′ is the BP for the fw-con adjacency from node 106 to node 112, and 1′ is the BP for the fw-con adjacency from node 112 to node 106. 2′ is configured on the link from node 106 to node 112 and advertised to all the network nodes in the network. 1′ is configured on the link from node 112 to node 106 and advertised to all the network nodes in the network. The other BPs for fw-con adjacencies may be determined in a similar fashion as represented by the various values for i′ on FIG. 1. For ease of discussion, each BP for fw-con adjacency may be simply referred to herein as the BP or the adjacency.

Each of the network nodes 104-120 may be referred to herein as a destination network node or a BFER. The network nodes 104-120 may each be assigned a BP, a set index or set identifier (SI), and a bitstring (a.k.a., BitString, Bit String, or bit string). The BP of a BFER is called a local decapsulation (decap) adjacency or local decap BP. In the illustrated example, the BP of a BFER is represented as j, where j is an integer corresponding to one of the local decap adjacencies in the BIER-TE domain 102. In the illustrated embodiment of FIG. 1, there are five local decap adjacencies for five BFERs 104, 110, 112, 114, and 118. As an example, the BPs of BFERs 104, 110, 112, 114, and 118 may be 5, 1, 3, 2, and 4, respectively. For simplicity, these BPs for local decap adjacencies are represented by (SI:BitString), where SI=0 and BitString is a string of 8 bits. BPs 1, 2, 3, 4, and 5 are collectively represented by 1 (0:00000001), 2 (0:00000010), 3 (0:00000100), 4 (0:00001000), and 5 (0:00010000), respectively. The BP of a BFER is advertised by the BFER to all the nodes in the network.

In an embodiment, the BPs for fw-con adjacencies are represented by (SI:BitString), where SI>=6 and BitString is a string of 8 bits. For example, the BP of 3′ has a SI of 6, and has a bitstring of 00000100 (collectively represented by 3′ (6:00000100). Assuming the SI of 6 corresponds to the first set of eight BPs for fw-con adjacencies, the BP of 3′ corresponds to the third bit in the bitstring from the right set to one. That is, when the SI is 6, the BP of 1′ corresponds to the first bit set to one, the BP of 2′ corresponds to the second bit set to one, the BP of 3′ corresponds to the third bit set to one, the BP of 4′ corresponds to the fourth bit set to one, and the BP of 5′ corresponds to the fifth bit set to one, and so on.

Assuming the SI of 7 corresponds to the second set of eight BPs for fw-con adjacencies immediately following the first set of eight BPs for fw-con adjacencies, the BPs of 9′ and 10′ are collectively represented by 9′ (7:00000001) and 10′ (7:00000010), respectively. That is, when the SI is 7, the BP of 9′ corresponds to the first bit set to one, and the BP of 10′ corresponds to the second bit set to one, and so on. In this way, the BP is represented by a number that indicates which bit is set in the BitString.

Each of the network nodes 104-120 has one or more neighbor nodes. As used herein, a neighbor node refers to a network node that is only one hop away from the network node. For example, network node 106 has four neighbor nodes in FIG. 1, namely network node 104, network node 108, network node 112, and network node 116. Indeed, each of network node 104, network node 108, network node 112, and network node 116 is only one hop away from network node 106.

The network nodes 104-120 in FIG. 1 are coupled to, and communicate with each other, via links 150. The links 150 may be wired, wireless, or some combination thereof. In an embodiment, each of the links 150 may have a cost. The cost of each of the links 150 may be the same or different, depending on the BIER-TE topology 100 and the conditions therein.

The BIER domain 102 is controlled by a network controller 130 (or simply, a controller) capable of implementing a routing protocol such as, for example, a border gateway protocol (BGP) or Intermediate-System Intermediate System (IS-IS). BGP is a standardized exterior gateway protocol designed to exchange routing and reachability information among autonomous systems (AS) on the Internet. BGP is classified as a path-vector routing protocol, and BGP makes routing decisions based on paths, network policies, or rule-sets configured by a network administrator. IS-IS (also written ISIS) is a routing protocol designed to move information efficiently within a computer network, a group of physically connected computers, or similar devices. IS-IS accomplishes this by determining the best route for data through a packet switching network.

In an embodiment, one or more of the network nodes 104-120 may request that the network controller 130 calculate the BIER-TE path through the BIER-TE domain 102. Once calculated, the BIER-TE path may be distributed by the network controller 130 in different ways.

For example, when the network controller 130 is directly connected to the ingress network node 104 of the BIER-TE path, the network controller 130 transmits an update message (a.k.a., a BGP update message) to the ingress network node 104 as well as one or more of the other network nodes 106-120. The update message includes a route target (RT) and a “no advertise” instruction. When the RT does not match the ID of the network node that received the update message, the network node is not the ingress network node of the BIER-TE path. Due to the “no advertise” instruction, the network nodes do not distribute the update message to their neighbor network nodes. When the RT does match the ID of the network node that received the update message, the network node is the ingress network node of the BIER-TE path (e.g., network node 104). As such, the ingress network node installs a forwarding entry for the BIER-TE path in a forwarding table stored on the ingress network node.

As another example, when the network controller 130 is not directly connected to the ingress network node 104 of the BIER-TE path, the network controller 130 transmits an update message to one or more of the other network nodes 106-120. The update message includes the RT and an “advertise” instruction. When the RT does not match the ID of the network node that received the update message, a network node advertises the update message to its neighbor network nodes according to the BGP propagation rules. Eventually, the ingress network node of the BIER-TE path, which has an ID that matches the RT, receives the update message from another network node. As such, the ingress network node installs a forwarding entry for the BIER-TE path in forwarding table stored on the ingress network node.

Additional details regarding the update message may be found in Internet Engineering Task Force (IETF) Request for Comments (RFC) 4271 entitled “A Border Gateway Protocol 4 (BGP-4)” by Y. Rekhter, et al., published January 2006.

Using the BIER-TE topology 100 of FIG. 1, an example of how the BIER-TE path calculated by the network controller 130 is utilized in the BIER-TE domain 102. To begin, assume the network controller 130 calculated a BIER-TE path from network node A to network nodes D and F, which is represented by the following BPs: {7′, 4′, 12′, 10′, 1, 2}, where 7′ and 4′ have an SI=6, 12′ and 10′ have an SI=7, and 1 and 2 have an SI=0. After the BIER-TE path has been calculated, the network controller 130 distributes that BIER-TE path to the ingress network node 104 for the BIER-TE path using an update message.

When the ingress network node 104 receives a packet (e.g., a multicast packet) from outside the BIER-TE domain 102, the ingress network node 104 encapsulates the packet with a BIER-TE header. Unfortunately, a conventional BIER-TE header only contains a set of bitstrings associated with one set identifier (e.g., either SI=0, SI=6, or SI=7). Because the conventional BIER-TE header can only have bitstrings for a single set identifier, the packet to be transported along the path cannot be delivered to the egresses of the path. An example to illustrate this point is provided below.

In order to route a packet, each of the network nodes 104-120 in the BIER-TE topology 100 in FIG. 1 generates a BIER-TE bit index forwarding table (BIFT). FIG. 2 is a schematic diagram of a BIFT 200 of a network node in the BIER-TE domain 102. In some cases, a BIER-TE BIFT may be referred to herein as a BIFT.

In the illustrated example, the BIER-TE BIFT 200 is built on the network node 104 in FIG. 1. As shown, the BIFT 200 includes three columns of information. The first column 202 includes the BP, SI, and BitString (a.k.a., bitstring) of each adjacency directly coupled to the network node 104 in the BIER-TE topology 100. The adjacency in column 202 may be a forward connected adjacency to a neighbor network node (e.g., network node 106) from network node 104 or a local decapsulation (local-decap) adjacency of a destination network node (e.g., destination network node 104). A second column 204 indicates the action to be taken by the network node 104, which in the illustrated example is either a forward connected adjacency or a local decapsulation (local-decap). At a local decapsulation, an egress network node decapsulates the received packet and forwards the payload to the multicast overlay (which forwards the payload to a customer receiver outside the BIER-TE domain) A third column 206 identifies the neighbor node (BFR-NBR) of the network node 104 used to reach the adjacent network node identified by the adjacency in the first column 202, which is why the neighbor node in the third column 206 may also be referred to as the next hop of the network node 104.

When the network node 104 receives a packet with a point-to-multipoint (P2MP) path (e.g., a BIER-TE path) including 7′, the network node 104 utilizes the first row 214 of the BIER-TE BIFT 200 to forward the packet. That is, the network node 104 sends the packet to the network node 106 (i.e., network node B) identified in the third column 206 based on the forward connected adjacency action in the second column 204. When the network node 104 receives a packet with a P2MP path including 5, the network node 104 utilizes the second row 216 of the BIER-TE BIFT 200 to forward the packet. That is, the network node 104 decapsulates the received packet and forwards the payload to the multicast overlay (which forwards the payload to a customer receiver outside the BIER-TE domain).

If, however, the path calculated by the controller 130 and delivered to the network node 104 includes multiple bitstrings with different set identifiers, problems may arise. For example, assume that the path is represented by {7′, 4′, 12′, 10′, 1, 2}, where 7′ and 4′ have an SI=6, 12′ and 10′ have an SI=7, and 1 and 2 have an SI=0. When network node 104 receives a packet to be transported along the path, the network node 104 makes a copy of the packet for each set identifier. In this case, three copies of the packet are made by the network node 104. Each copy of the packet contains a BIER-TE header (or simply, header) with one of the set identifiers and a bitstring. As used herein, the bitstring may be referred to herein as a set of bitstrings.

The first copy of the packet (copy 1) includes a BIER-TE header with the set identifier 0 and the bitstring 00000011 for bit positions 1 and 2 in the path, which is represented as (0:00000011). The second copy of the packet (copy 2) includes a BIER-TE header with the set identifier 6 and the bitstring 01001000 for bit positions 7′ and 4′ in the path, which is represented as (6:01001000). The third copy of the packet (copy 3) includes a BIER-TE header with the set identifier 7 and the bitstring 00001010 for bit positions 12′ and 10′ in the path, which is represented as (7:00001010).

The network node 104 will drop the first copy of the packet because bit positions 1 and 2 are not any adjacency bit of the network node 104. That is, the BIER-TE BIFT 200 of network node 104 does not include bit positions 1 and 2. Similarly, the network node 104 will drop the third copy of the packet because bit positions 12′ and 10′ are not any adjacency bit of the network node 104. That is, the BIER-TE BIFT 200 of network node 104 does not include bit positions 12′ and 10′. Because the BIER-TE BIFT 200 of network node 200 includes bit position 7′, the network node 104 transmits or forwards the second copy of the packet to network node 106 (a.k.a., network node B).

After receiving the second copy of the packet, the network node 106 sends the second copy of the packet to network node 108 using bit position 4′ in the header because the network node 106 has an adjacency of 4′. That is, the BIER-TE BIFT of the network node 106 (not shown) indicates that the next hop corresponding to an adjacency of 4′ is the network node 108 (a.k.a., network node C). Thereafter, the network node 108 drops the second copy of the packet because there is no bit position of the network node 108 in the header of the second copy of the packet. As such, no copy of the packet reaches the intended destination network nodes 110 and 114 identified in the path received from the controller 130.

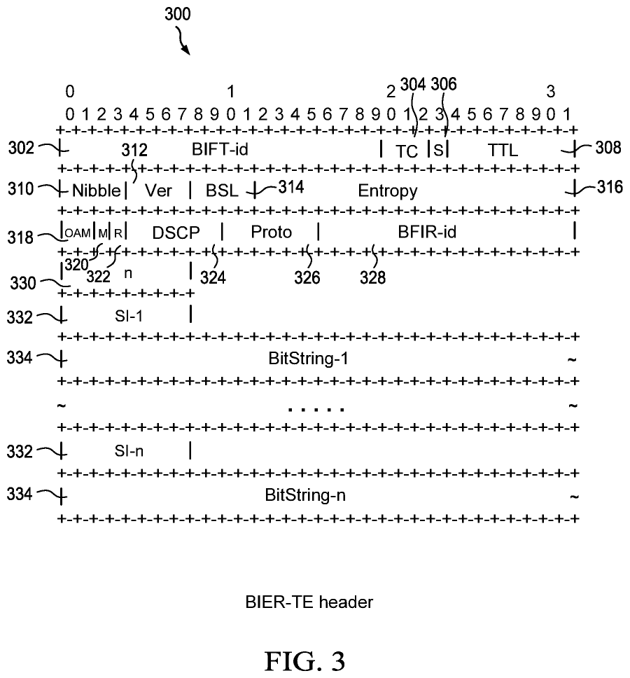

FIG. 3 is a schematic diagram of a BIER-TE header 300 according to an embodiment of the disclosure. As will be more fully explained below, the BIER-TE header 300 is configured to resolve one or more of the problems disclosed herein.

The BIER-TE header 300 includes a BIFT-id field 302, a traffic class field 304, an S bit field 306, a time to live (TTL) field 308, a nibble field 310, a version field 312, a bitstring length (BSL) field 314, an entropy field 316, an operations administration maintenance (AOM) field 318, an M flag field 320, an R flag field 322, a Differentiated Services Code Point (DSCP) field 324, a protocol (Proto) field 326, a BFIR-id field 328, a number of sets of bitstrings field 330, a set identifier field 332, and a bitstring field 334. While a brief description of each of the fields is provided below, additional details for one or more of the fields may be found in Internet Engineering Task Force (IETF) Request for Comments (RFC) 8296 entitled “Encapsulation for Bit Index Explicit Replication (BIER) in MPLS and Non-MPLS Networks” by I J. Wijnands, et al., published January 2018.

The BIFT-id field 302 includes a value that represents a particular BIFT (e.g., BIER-TE BIFT 200 in FIG. 2). The traffic class field 304 includes a value that identifies a traffic class as described in IETF RFC 5462 entitled “Multiprotocol Label Switching (MPLS) Label Stack Entry: “EXP” Field Renamed to “Traffic Class” Field” by L. Andersson, et al., published February 2009.

The S bit field 306 includes a value that indicates whether a packet (e.g., a BIER packet) traveling through a BIER network (e.g., BIER network 100) includes any MPLS stack entries. The TTL field 308 includes a value that indicates whether the packet is expired and must be dropped or whether the packet is to be further processed. Additional details regarding the S bit field 306 and the TTL field 308 are described in IETF RFC 3032 entitled “MPLS Label Stack Encoding,” by E. Rosen, et al., published January 2001.

The nibble field 310 includes a value that ensures the BIER-TE header 300 will not be confused with being another header. For example, the nibble field 310 includes the binary value 0101 so that the BIER header 300 is not confused with an Internet Protocol (IP) header or a pseudowire header. The version field 312 includes a value that identifies a version of the BIER-TE header 300.

The BSL field 314 includes a value that specifies a length in bits of a bitstring. If k is the length of the BitString, the value of this field is log 2(k)−5. For example, when the value in the BSL field is three (3), each bitstring includes 256 bits. The entropy field 316 includes an entropy value that can be used for load-balancing purposes. The BIER forwarding process may do equal-cost load balancing, in which case the load-balancing procedure chooses the same path for any two packets that have the same entropy value and the same bitstring. Additional details on BIER load-balancing procedures are found in Section 6.7 of IETF RFC 8279.

The OAM field 318 includes a value as set by a BFIR (e.g., network node 104). In an embodiment, the value is set to zero and have no effect on the quality of service applied to the BIER packet.

The M field 320 includes a value indicating whether or not the BIER-TE header 300 contains multiple bitstrings with different set identifiers. In an embodiment, the M field 320 is referred to as a one-bit flag. When the one-bit flag is set to 1, the BIER-TE header 300 contains multiple sets of bitstrings. When the one-bit flag is set to 0, the BIER-TE header 300 does not contain multiple sets of bitstrings. In an embodiment, the M field 320 is optional.

The R field 322 is reserved for later use. In an embodiment, the R field 322 is set to a value of zero upon transmission of the BIER-TE header 300 and is ignored upon receipt thereof. In similar fashion, the DSCP field 324 is also set to a value of zero upon transmission of the BIER-TE header 300 and is ignored upon receipt thereof.

The Proto field 326, which is also referred to as the next protocol field, is set to a value that identifies the type of payload being carried by the packet. In an embodiment, the payload is the packet or frame immediately following the BIER-TE header 300.

The BFIR-id field 328 includes a value that identifies the BFR-id of the BFIR in the domain (e.g., the BIER-TE domain 102) to which the packet has been assigned. In an embodiment, the value is an unsigned integer in a range of [1, 65535].

The n field 330 includes a value that indicates the number of sets of bitstrings (a.k.a., the number of bitstrings) in the BIER-TE header 300. When the number has a value greater than one, the BIER-TE header 300 contains multiple bitstrings with different set identifiers. When the number has a value of one, the BIER-TE header 300 does not contain multiple bitstrings with different set identifiers. For example, the BIER-TE header 300 contains only one bitstring when the number has a value of one.

The set identifier field 332 includes a value that identifies a corresponding bitstring in the bitstring field 334. For example, the set identifier SI-1 is the set identifier for the first bitstring BitString-1, the set identifier SI-2 is the set identifier for the second bitstring BitString-2, and so on. The set identifier SI-n is the set identifier for the n-th bitstring BitString-n, where n corresponds to the value in the n field 330. That is, the number of set identifiers and bitstrings in the BIER-TE header 300 corresponds to the value in the n field 330.

In an embodiment, each set identifier is a numerical value (e.g., from 0 to 8) and each bitstring is a binary string of values (e.g., 00010010) as described herein. In an embodiment, a length of each bitstring in the bitstring field 334 is indicated by the value in the BSL field 314.

Each BFR (e.g., network node 104, 106, etc.) has two levels of forwarding tables for BIER-TE. In particular, each BFR includes a top level BIFT (a.k.a., a first level BIFT) and one or more second level BIFTs. As will be more fully explained below, the top level BIFT includes an entry for each set identifier while the second level BIFT is similar to the BIFT 200 in FIG. 2.

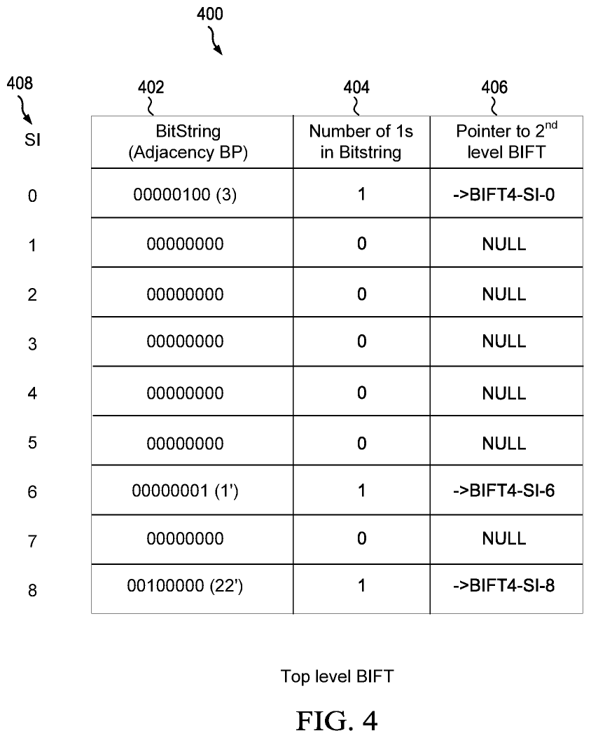

FIG. 4 is a schematic diagram of a top level BIFT 400 according to an embodiment of the disclosure. The top level BIFT 400 is disposed on the network node 112 (i.e., network node E), which has the adjacency bit positions 3, 1′, and 22′ is set 0, 6, and 8, respectively.

As shown, the top level BIFT 400 includes a bitstring column 402, a number of ones (1s) in bitstring column 404, a pointer to second (2^{nd}) level BIFT column 406, and an SI column 408. The bitstring column 402 includes one or more bitstrings. In an embodiment, the bitstring comprises a string of binary values. The length of the bitstring may vary in practical applications. For example, the bitstrings may have a length of 64, 128, 256, etc., in practical applications. Each bitstring in the bitstring column 402 represents the adjacency bit positions (BPs) of the BFR for the corresponding SI in the SI column 408.

For example, the bitstring in the row of the top level BIFT 400 corresponding to the SI of 0 is 00000100. Because the third bit from the right in the bitstring is set to a value of one (1), the bitstring indicates that the BFR has a local-decap adjacency BP of 3. Similarly, the bitstring in the row of the top level BIFT 400 corresponding to the SI of 6 is 00000001. Because the first bit from the right in the bitstring is set to a value of one (1), the bitstring indicates that the BFR has a forward-connected adjacency BP of 1′. In addition, the bitstring in the row of the top level BIFT 400 corresponding to the SI of 8 is 00100000. Because the sixth bit from the right in the bitstring is set to a value of one (1), the bitstring indicates that the BFR has a forward-connected adjacency BP of 22′. Finally, the bitstrings in the rows of the top level BIFT 400 corresponding to the SI of 1, 2, 3, 4, 5, and 7 are 00000000. Because none of the bits are set to a value of one (1), the bitstring indicates that the BFR does not have a local-decap adjacency or a forward-connected adjacency for those SIs.

The number of ones in bitstring column 404 indicates how many bits in the bitstring of that row are set to one (1). For example, the row of the top level BIFT 400 corresponding to the SIs of 0, 6, and 8 each have one bit in the bitstring set to one (1). Therefore, there is a value of one (1) in the number of ones in bitstring column 404 for each of those rows. Because the bitstrings in the BIFT 400 corresponding to the SI of 1, 2, 3, 4, 5, and 7 are all 00000000, the value in the number of ones in bitstring column is zero (0). In an embodiment, the number of ones in bitstring column 404 is optional.

The pointer to second level BIFT column 406 includes a pointer to a second level BIFT for each of the SIs that have a bitstring in the bitstring column 402 containing a value of one (1). For example, the row of the top level BIFT 400 corresponding to the SI of 0 has a bitstring with a value of 1. As such, the pointer to second level BIFT column 406 includes a pointer to a second level BIFT for the SI of 0. Similarly, the row of the top level BIFT 400 corresponding to the SI of 6 has a bitstring with a value of 1. As such, the pointer to second level BIFT column 406 includes a pointer to a second level BIFT for the SI of 6. In addition, the row of the top level BIFT 400 corresponding to the SI of 8 has a bitstring with a value of 1. As such, the pointer to second level BIFT column 406 includes a pointer to a second level BIFT for the SI of 8.

In the illustrated embodiment of FIG. 4, the top level BIFT 400 includes nine entries (i.e., rows). In the illustrated embodiment, there are nine sets of bitstrings in the BIER-TE network. Therefore, the top level BIFT 400 includes nine entries. However, the top level BIFT 400 may have more or fewer entries in practical applications.

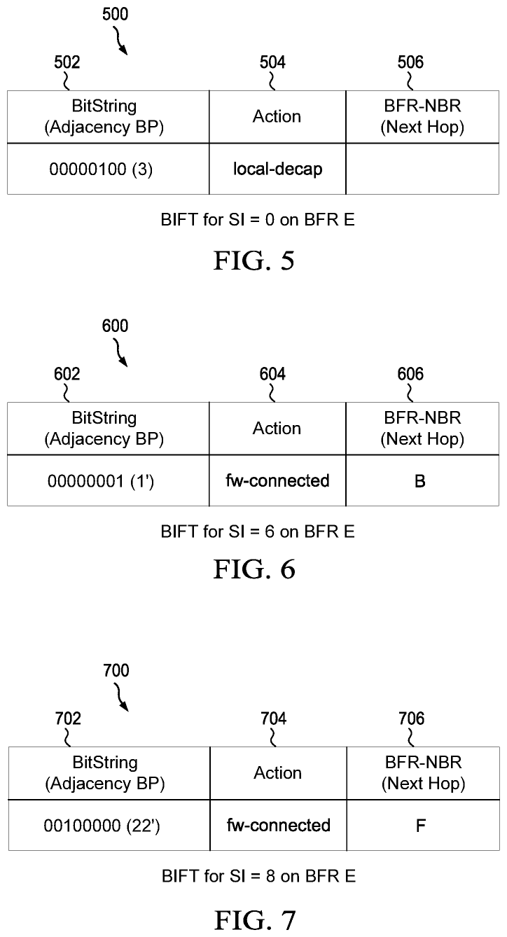

FIG. 5 is a second level BIFT 500 according to an embodiment of the disclosure. The second level BIFT 500 is disposed on the network node 112 (i.e., network node E) and is for the SI of 0. The pointer in the row of the top level BIFT 400 associated with the SI of 0 (which is represented as ->BIFT4-SI-0) points to the second level BIFT 500 in FIG. 5.

As shown, the second level BIFT 500 includes a bitstring column 502, an action column 504, and a BFR-NBR column 506. The first column 502 includes the bitstring of each adjacency bit position directly coupled to the network node 112 in the BIER-TE topology 100. The adjacency in column 502 may be a forward connected adjacency to a neighbor network node or a local-decap adjacency of a destination network node. A second column 504 indicates the action to be taken by the network node 112, which in the illustrated example is a local decapsulation. At a local decapsulation, an egress network node decapsulates the received packet and forwards the payload to the multicast overlay (which forwards the payload to a customer receiver outside the BIER-TE domain) A third column 506 identifies the BFR-NBR of the network node 112 used to reach the adjacent network node identified by any forward connected adjacency in the first column 502. Because there is no forward connected adjacency in the first column, the third column 606 in the second level BIFT 500 is blank.

FIG. 6 is a second level BIFT 600 according to an embodiment of the disclosure. The second level BIFT 600 is disposed on the network node 112 (i.e., network node E) and is for the SI of 6. The pointer in the row of the top level BIFT 400 associated with the SI of 6 (which is represented as ->BIFT4-SI-6) points to the second level BIFT 600 in FIG. 6.

As shown, the second level BIFT 600 includes a bitstring column 602, an action column 604, and a BFR-NBR column 606. The first column 602 includes the bitstring of each adjacency bit position directly coupled to the network node 112 in the BIER-TE topology 100. The adjacency in column 602 may be a forward connected adjacency to a neighbor network node or a local-decap adjacency of a destination network node. A second column 604 indicates the action to be taken by the network node 112, which in the illustrated example is a forward connected adjacency. A third column 606 identifies the BFR-NBR of the network node 112 used to reach the adjacent network node identified by the forward-connected adjacency in the first column 602. Because the first column 602 indicates a forward-connected adjacency of 1′, which is the adjacency used to reach the network node 106 (i.e., network node B), the third column 606 in the second level BIFT 600 includes the destination B.

FIG. 7 is a second level BIFT 700 according to an embodiment of the disclosure. The second level BIFT 700 is disposed on the network node 112 (i.e., network node E) and is for the SI of 8. The pointer in the row of the top level BIFT 400 associated with the SI of 8 (which is represented as ->BIFT4-SI-8) points to the second level BIFT 700 in FIG. 7.

As shown, the second level BIFT 700 includes a bitstring column 702, an action column 704, and a BFR-NBR column 706. The first column 702 includes the bitstring of each adjacency bit position directly coupled to the network node 112 in the BIER-TE topology 100. The adjacency in column 702 may be a forward connected adjacency to a neighbor network node or a local-decap adjacency of a destination network node. A second column 704 indicates the action to be taken by the network node 112, which in the illustrated example is a forward connected adjacency. A third column 706 identifies the BFR-NBR of the network node 112 used to reach the adjacent network node identified by the forward-connected adjacency in the first column 702. Because the first column 702 indicates a forward-connected adjacency of 22′, which is the adjacency used to reach the network node 114 (i.e., network node F), the third column 706 in the second level BIFT 700 includes the destination F.

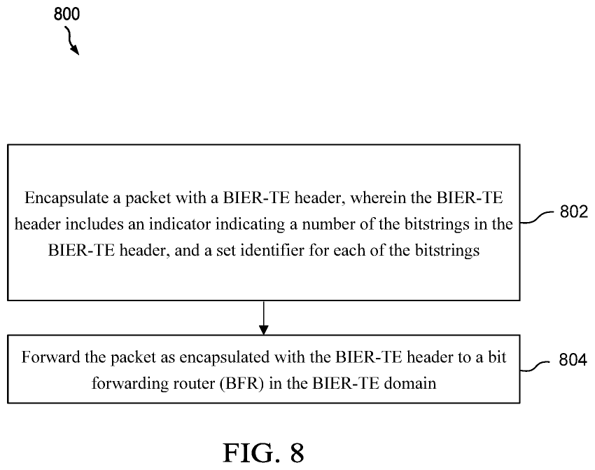

FIG. 8 is a method 800 implemented by a BFIR in a BIER-TE domain according to an embodiment of the disclosure. The method 800 may be performed to route a packet through the BIER-TE domain.

In block 802, the BFIR encapsulates a packet with a BIER-TE header (e.g., the BIER-TE header 300 of FIG. 3). The BIER-TE header includes an indicator (e.g., n in the number of sets of bitstrings field 330) indicating a number of the bitstrings with different set identifiers in the BIER-TE header, and a set identifier for each of the bitstrings (e.g., SI-1, SI-2, . . . SI-n in the set identifier field 332). The number n greater than one (1) indicates the BIER-TE header contains multiple bitstrings with different set identifiers. The number n equal to one (1) indicates the BIER-TE header does not contain multiple bitstrings with different set identifiers.

In block 804, the BFIR forwards the packet as encapsulated with the BIER-TE header to a BFR in the BIER-TE domain.

In an embodiment, the bitstrings with different set identifiers in the BIER-TE header represent a path through the BIER-TE domain. In an embodiment, the path is received from a controller (e.g., the controller 130) of the BIER-TE domain prior to the encapsulating. In an embodiment, the number has the value of greater than one (1) when the BIER-TE header contains the multiple bitstrings with the different set identifiers. In an embodiment, the number has the value of one (1) when the BIER-TE header does not contain the multiple bitstrings with the different set identifiers.

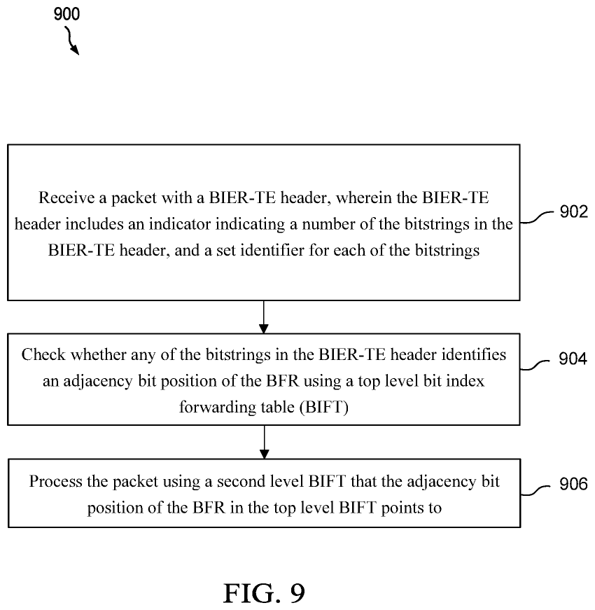

FIG. 9 is a method 900 implemented by a BFR in a BIER-TE domain according to an embodiment of the disclosure. The method 900 may be performed to route a packet through the BIER-TE domain.

In block 902, the BFR receives a packet with a BIER-TE header (e.g., BIER-TE header 300). In an embodiment, the BIER-TE header includes an indicator (e.g., n in the number of sets of bitstrings field 330) indicating a number of the bitstrings with different set identifiers in the BIER-TE header, and a set identifier for each of the bitstrings (e.g., SI-1, SI-2, . . . SI-n in the set identifier field 332). The number n greater than one (1) indicates the BIER-TE header contains multiple bitstrings with different set identifiers. The number n equal to one (1) indicates the BIER-TE header does not contain multiple bitstrings with different set identifiers.

In block 904, the BFR checks whether a bitstring identified by the set identifier in the BIER-TE header and a bitstring identified by the set identifier in a top level BIFT each contain an adjacency bit position of the BFR with a same value.

In block 906, the BFR processes the packet using a second level BIFT that a pointer for the set identifier in the top level BIFT points to when the bitstring identified by the set identifier in the BIER-TE header and the bitstring identified by the set identifier in the BIFT each contain the adjacency bit position of the BFR with the same value.

In an embodiment, processing the packet using the second level BIFT comprises forwarding a copy of the packet to an adjacent bit forwarding router (BFR) when the adjacency bit position is a forward-connected adjacency. In an embodiment, processing the packet using the second level BIFT comprises forwarding a payload of the packet according to a next protocol when the adjacency bit position is a local decapsulation adjacency.

In an embodiment, each bitstring in the BIER-TE header and each bitstring in the top level BIFT is identified by one of the set identifiers. In an embodiment, the same value comprises one (1). In an embodiment, the second level BIFT is one of a plurality of second level BIFTs in the BFR.

In an embodiment, each of the plurality of second level BIFTs in the BFR corresponds to one of the set identifiers. In an embodiment, the top level BIFT includes a pointer to a second level BIFT for each of the set identifiers.

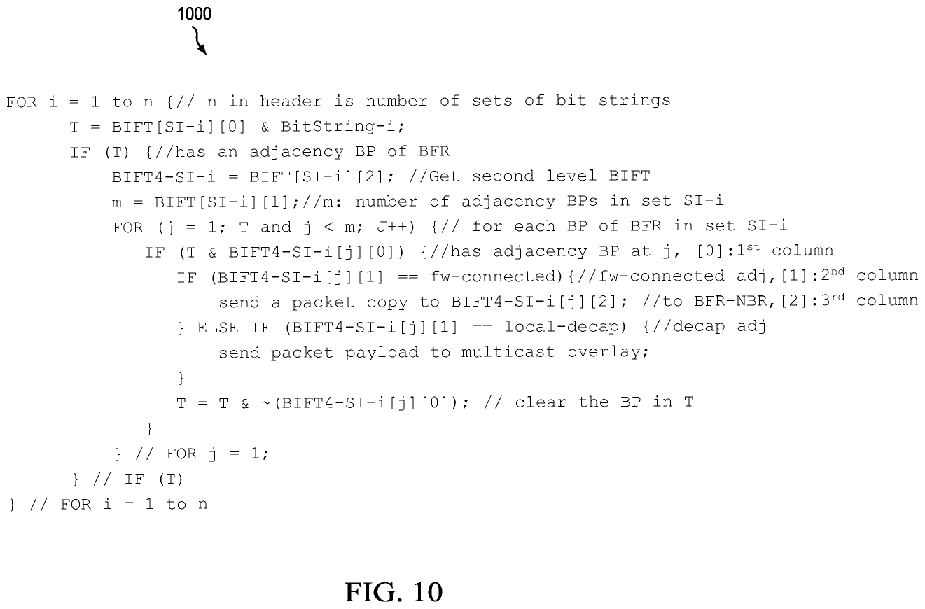

FIG. 10 is syntax suitable for implementing an enhanced forwarding procedure that corresponds to the method 900 of FIG. 9 according to an embodiment of the disclosure.

For a bitstring identified by SI-i and BitString-i, the BFR determines whether the bitstring contains an adjacency bit position of the BFR using the top level BIFT. The BFR gets its adjacency bit positions in the set SI-i from the BIFT and checks whether BitString-i and the bit positions have the same bit with value 1. This can be achieved by checking whether BIFT[SI-i][0] AND BitString-i are not zero, where BIFT[SI-i][0] is the adjacency bit position of the BFR in the set SI-i, and where AND is bit wise logical AND function.

When BitString-i contains an adjacency bit position of the BFR, the BFR processes the packet using the second level BIFT for its adjacency bit positions in the BitString identified by SI-i. The BFR gets the second level BIFT from the top level BIFT using SI-i. The second column of the row with index SI-i in the top level BIFT (i.e., BIFT[SI-i][1]) stores a pointer to the second level BIFT when the top level BIFT does not contain column “Number of 1s in BitString”.

For each adjacency bit position of the BFR in the BitString, the BFR processes the packet using the second level BIFT pointed by BIFT[SI-i][1] in the same way as the packet is processed using, for example, the BIER-TE BIFT 200 of FIG. 2.

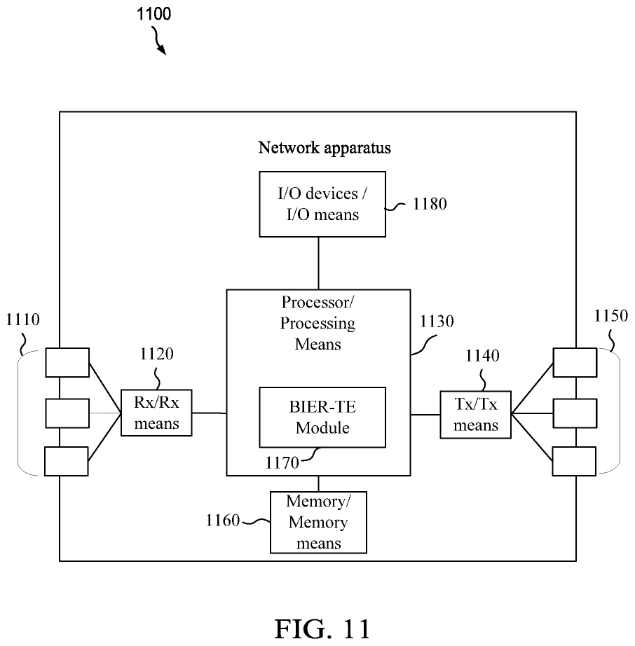

FIG. 11 is a schematic diagram of a network apparatus 1100 (e.g., a network controller, a network node, etc.). The network apparatus 1100 is suitable for implementing the disclosed embodiments as described herein. The network apparatus 1100 comprises ingress ports/ingress means 1110 (a.k.a., upstream ports) and receiver units (Rx)/receiving means 1120 for receiving data; a processor, logic unit, or central processing unit (CPU)/processing means 1130 to process the data; transmitter units (Tx)/transmitting means 1140 and egress ports/egress means 1150 (a.k.a., downstream ports) for transmitting the data; and a memory/memory means 1160 for storing the data. The network apparatus 1100 may also comprise optical-to-electrical (OE) components and electrical-to-optical (EO) components coupled to the ingress ports/ingress means 1110, the receiver units/receiving means 1120, the transmitter units/transmitting means 1140, and the egress ports/egress means 1150 for egress or ingress of optical or electrical signals.

The processor/processing means 1130 is implemented by hardware and software. The processor/processing means 1130 may be implemented as one or more CPU chips, cores (e.g., as a multi-core processor), field-programmable gate arrays (FPGAs), application specific integrated circuits (ASICs), and digital signal processors (DSPs). The processor/processing means 1130 is in communication with the ingress ports/ingress means 1110, receiver units/receiving means 1120, transmitter units/transmitting means 1140, egress ports/egress means 1150, and memory/memory means 1160. The processor/processing means 1130 comprises a BIER-TE module 1170. The BIER-TE module 1170 is able to implement the methods disclosed herein. The inclusion of the BIER-TE module 1170 therefore provides a substantial improvement to the functionality of the network apparatus 1100 and effects a transformation of the network apparatus 1100 to a different state. Alternatively, the BIER-TE module 1170 is implemented as instructions stored in the memory/memory means 1160 and executed by the processor/processing means 1130.

The network apparatus 1100 may also include input and/or output (I/O) devices or I/O means 1180 for communicating data to and from a user. The I/O devices or I/O means 1180 may include output devices such as a display for displaying video data, speakers for outputting audio data, etc. The I/O devices or I/O means 1180 may also include input devices, such as a keyboard, mouse, trackball, etc., and/or corresponding interfaces for interacting with such output devices.

The memory/memory means 1160 comprises one or more disks, tape drives, and solid-state drives and may be used as an over-flow data storage device, to store programs when such programs are selected for execution, and to store instructions and data that are read during program execution. The memory/memory means 1160 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a bit forwarding ingress router (BFIR) in a Bit Index Explicit Replication Traffic/Tree Engineering (BIER-TE) domain, comprising:
encapsulating a packet with a BIER-TE header, wherein the BIER-TE header includes an indicator indicating a number of bitstrings with different set identifiers in the BIER-TE header, and a set identifier for each of the bitstrings; and
forwarding the packet as encapsulated with the BIER-TE header to a bit forwarding router (BFR) in the BIER-TE domain.

2. The method of claim 1, wherein the bitstrings with different set identifiers in the BIER-TE header represent a path through the BIER-TE domain.

3. The method of claim 2, wherein the path is received from a controller of the BIER-TE domain prior to the encapsulating.

4. The method of claim 1, wherein the number has a value greater than one (1) when the BIER-TE header contains multiple bitstrings with the different set identifiers.

5. The method of claim 1, wherein the number has a value of one (1) when the BIER-TE header does not contain multiple bitstrings with the different set identifiers.

6. A bit forwarding ingress router (BFIR) in a Bit Index Explicit Replication Traffic/Tree Engineering (BIER-TE) domain, comprising:
a memory storing instructions; and
a processor coupled to the memory, the processor configured to execute the instructions to cause the BFIR to:
encapsulate a packet with a BIER-TE header, wherein the BIER-TE header includes an indicator indicating a number of bitstrings with different set identifiers in the BIER-TE header, and a set identifier for each of the bitstrings; and
forward the packet as encapsulated with the BIER-TE header to a bit forwarding router (BFR) in the BIER-TE domain.

7. The BFIR of claim 6, wherein the bitstrings with different set identifiers in the BIER-TE header represent a path through the BIER-TE domain.

8. The BFIR of claim 7, wherein the path is received from a controller of the BIER-TE domain prior to the encapsulating.

9. The BFIR of claim 6, wherein the number has a value greater than one (1) when the BIER-TE header contains multiple bitstrings with the different set identifiers.

10. The BFIR of claim 6, wherein the number has a value of one (1) when the BIER-TE header does not contain multiple bitstrings with the different set identifiers.

11. A method implemented by a bit forwarding router (BFR) in a Bit Index Explicit Replication Traffic/Tree Engineering (BIER-TE) domain, comprising:
receiving a packet with a BIER-TE header, wherein the BIER-TE header includes an indicator indicating a number of bitstrings with different set identifiers in the BIER-TE header, and a set identifier for each of the bitstrings;
checking whether a bitstring identified by the set identifier in the BIER-TE header and a bitstring identified by the set identifier in a top level bit index forwarding table (BIFT) each contain an adjacency bit position of the BFR with a same value; and
processing the packet using a second level BIFT that a pointer for the set identifier in the top level BIFT points to when the bitstring identified by the set identifier in the BIER-TE header and the bitstring identified by the set identifier in the BIFT each contain the adjacency bit position of the BFR with the same value.

12. The method of claim 11, wherein processing the packet using the second level BIFT comprises forwarding a copy of the packet to an adjacent bit forwarding router (BFR) when the adjacency bit position is a forward-connected adjacency.

13. The method of claim 11, wherein processing the packet using the second level BIFT comprises forwarding a payload of the packet according to a next protocol when the adjacency bit position is a local decapsulation adjacency.

14. The method of claim 11, wherein each bitstring in the BIER-TE header and each bitstring in the top level BIFT is identified by one of the set identifiers.

15. The method of claim 11, wherein the same value comprises one (1).

16. The method of claim 11, wherein the second level BIFT is one of a plurality of second level BIFTs in the BFR.

17. The method of claim 16, wherein each of the plurality of second level BIFTs in the BFR corresponds to one of the set identifiers.

18. The method of claim 11, wherein the top level BIFT includes a pointer to a second level BIFT for each of the set identifiers.

19. A bit forwarding router (BFR) in a Bit Index Explicit Replication Traffic/Tree Engineering (BIER-TE) domain, comprising:
a memory storing instructions; and
a processor coupled to the memory, the processor configured to execute the instructions to cause the BFR to:
receive a packet with a BIER-TE header, wherein the BIER-TE header includes an indicator indicating a number of bitstrings with different set identifiers in the BIER-TE header, and a set identifier for each of the bitstrings;
check whether a bitstring identified by the set identifier in the BIER-TE header and a bitstring identified by the set identifier in a top level bit index forwarding table (BIFT) each contain an adjacency bit position of the BFR with a same value; and
process the packet using a second level BIFT that a pointer for the set identifier in the top level BIFT points to when the bitstring identified by the set identifier in the BIER-TE header and the bitstring identified by the set identifier in the BIFT each contain the adjacency bit position of the BFR with the same value.

20. The BFR of claim 19, wherein the processor processes the packet using the second level BIFT by forwarding a copy of the packet to an adjacent BFR when the adjacency bit position is a forward-connected adjacency.
